(19) United States
(12) Patent Application Publication
(10) Pub. No.: US 2008/0013407 A1
(43) Pub. Date: Jan. 17, 2008

(54) Proportional count down timer

(76) Inventor: Julie Rauchle, Larkspur, CA (US)

Correspondence Address: Julie Rauchle, 67 Creek View Circle, Larkspur, CA, 94939, US

(21) Appl. No.: 11/485,746

(22) Filed: Jul. 12, 2006

(51) Int. Cl. G04F 8/00; G04F 10/00

(52) U.S. Cl. 368/108

(57) ABSTRACT

Proportional count down timer with a housing, a tamper proof time setting cover, a printed circuit board, an LCD display, a visual proportion display, an auditory signal, a count down timing circuit, a power supply and a plurality of time setting switches. The time setting switches are accessible by removal of the time setting cover. The time setting switches are capable of setting days, hours and minutes which will then start counting down upon pressing the start switch. The LCD display shows the amount of actual time left after the push of the start switch. The visual proportion display, such as a series of LED's, shows the proportion of time left in relation to the total time programmed when user views the lit LED's and as they sequentially turn off until they are all off at the end of the total elapsed time.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of timers and more specifically to a proportional count down timer.

Time keeping devices such as watches and clocks are well known. Time keeping devices can be mechanical such as a wind up spring assembly, or electronic such as a watch or clock that includes an electronic display such as an LCD screen. Combination mechanical and electronic time keeping devices can be seen in electronic quarts crystal movements that are coupled to a gear mechanism that results in an analogue display of moving clock hands found in many wrist watches.

One type of time keeping device is known as a count down timer. One type of count down timer is a mechanical type where the user turns a knob to the selected time and then the turned portion reverses direction until the time has reached zero at which point an audible alarm sounds. Another type of count down timer is an electronic type that uses an LCD display to both set the total time to be counted and to then show the elapsed time as it diminishes minute by minute or second by second until the time reaches zero at which time an audio signal sounds.

Although the electronic count down timers of today are quite functional for many uses, there are a number of deficiencies in the prior technology when the timer is being used in certain circumstances. For example, a child who does not yet know how to read time can not benefit from a standard count down timer. If a family is taking a road trip and the child is told that the trip will take four hours, the child may not have an idea of how long four hours really is and may not know how much time has elapsed in relation to the total time of the trip. As a result the child may continually ask how much time is left. In the case of a person who can read time, he or she may be using a standard count down timer for a purpose such as monitoring the amount of time food is being cooked. That person may have difficulty reading the LCD display from a distance and may also have difficulty in knowing the proportion of time that has elapsed in relation to the total time set by the user. For example, a food recipe may call for adding an ingredient half way through the cooking process. It would be helpful to see a display that quickly shows that half the time has elapsed. Finally, most common count down timers only show time in terms of hours, minutes and seconds and not in terms of days. There may be instances, such as counting the number of days left until a holiday or a birthday, where having a day counting function would be helpful in addition to an hour and minute function.

### BRIEF SUMMARY OF THE INVENTION

The primary object of the invention is to provide an electronic count down timer that visually shows the amount of time left in proportion to the total time set by the user.

Another object of the invention is to provide a proportional count down timer that includes a tamper proof cover that lets an adult set the time and replace the cover so that a child can not have access to the time setting feature. Another object of the invention is to provide a count down timer that can count down in minutes, hours and or days.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed proportional count down timer comprising: a housing including a top and bottom cover, a tamper proof time setting cover, a printed circuit board, an LCD display, a visual proportion display, an auditory signaling device, a micro-controller circuit, a power supply such as a battery, a battery holder, a battery cover, a plurality of standard time setting switches including a day function, an hour function and a minute function and a start switch, a switch that activates said visual proportion display, said LCD display, said proportion display and said proportion display switch visible through apertures in said top housing, said battery and said time setting switches accessible by removal of said tamper proof time setting cover, said time setting switches capable of setting a time including days, hours and minutes which will then start counting down upon pressing said start switch, said LCD display showing amount of actual time left after the push of said start switch, said visual proportion display showing the proportion of time left after the push of said start switch in relationship to total set time: and said auditory signal sounding when the time left reaches zero.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is top plan view of the proportional count down timer of the present invention.

FIG. 2 is a bottom plan view of the present invention.

FIG. 3 is a side view of the present invention.

FIG. 4 is a partial bottom view of the invention with the tamper proof cover removed.

FIG. 5 is is a partial exploded perspective view of the time setting portion of the invention.

FIG. 6 is an exploded view of the present invention.

FIG. 7 is a partial exploded view of the LCD portion of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

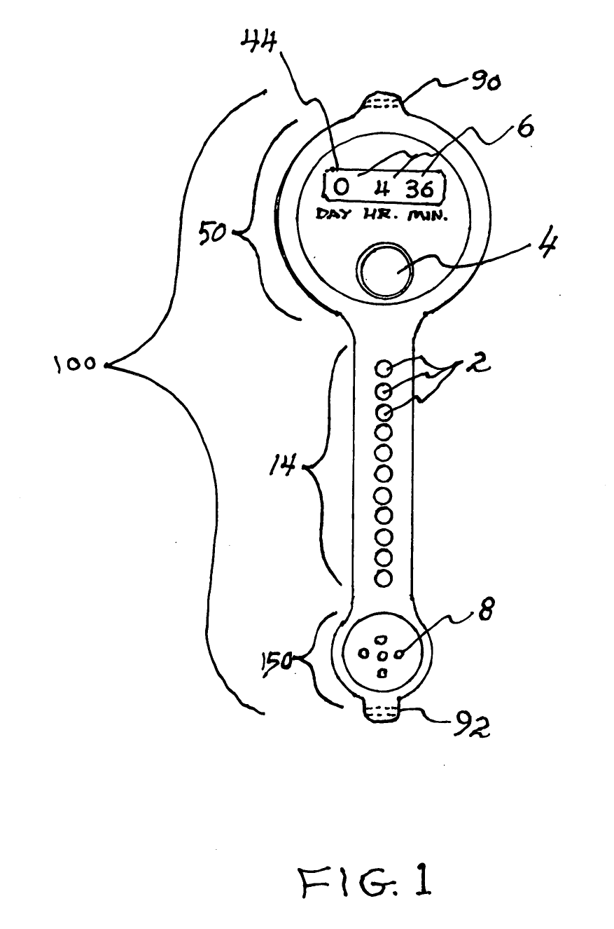

Referring now to FIG. 1 we see a top plan view of the proportional electronic count down timer of the present invention 100. The invention's housing holds a time indicating and setting portion 50, a visual proportion indicating portion 14 and an audile alarm portion 150. The time is indicated via an LCD screen 6 which appears through a transparent lens 44 located in the otherwise opaque housing portion 50. Also located within housing area 50 is a portion indicating activation switch 4 which, when pressed, causes the LED's 2 in proportion indicator section 14 to light up for a period of time. As the actual time diminishes with respect to the set time, the number of LED's 2 that remain lit decrease. For example, if the original set time is one hour, and thirty minutes of that hour have elapsed, then five of the ten LED's 2 will remain lit. If the user presses the indicating switch once, the LED's remain lit for a short time, such as five seconds thereby conserving battery life. If the user presses the switch 4 twice in rapid succession, the LED's 2 will remain on continuously for use in situations where proportional time remaining must be read from a distance such as from one side of a kitchen to another. The proportional time portion 14 is especially useful for small children who are just learning the concept of time. With the present invention, the question “how much time is left?” or “when will we be there?” can be answered by having the child look at the proportional time display 14 and informing the child that “we will be there when all the lights go out”. Additionally, when the set time period is complete, an audible alarm sound is emitted through apertures 8 in the alarm portion 150. A child may wear the invention 100 around his or her neck by attaching a cord or necklace through one or the other apertures in the housing shown by dotted lines 90, 92. The time period can be set for minutes, hours or days, so even the time remaining for an event such as a holiday or birthday can be proportionately seen by display 14. For example if a child's birthday is happening eight days from now and the timer is set for eight days, after four days, half of the LED's will remain lit, showing the child in graphic terms that he or she is half way there from the time he or she started counting.

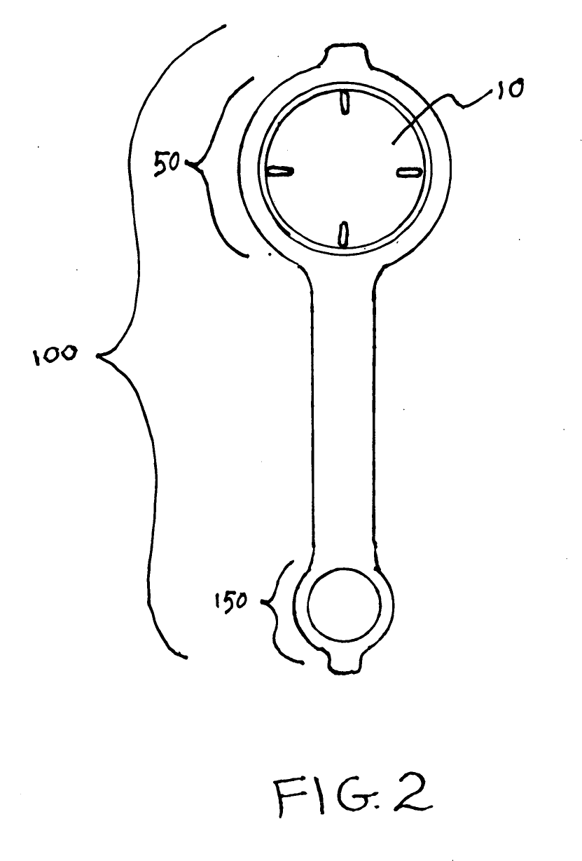

FIG. 2 shows a rear plan view of the invention 100 where removable cover 10 can be easily seen. The function of cover 10 will be discussed below.

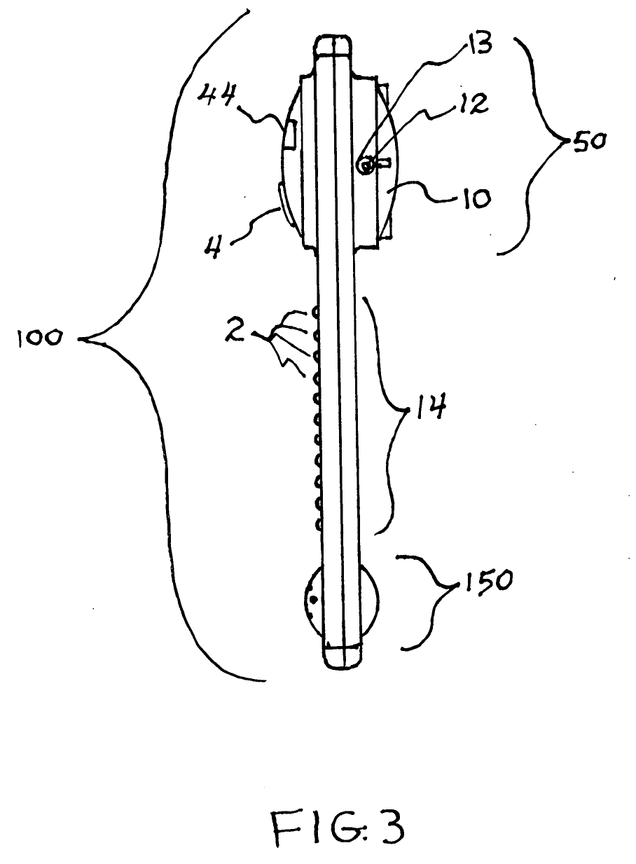

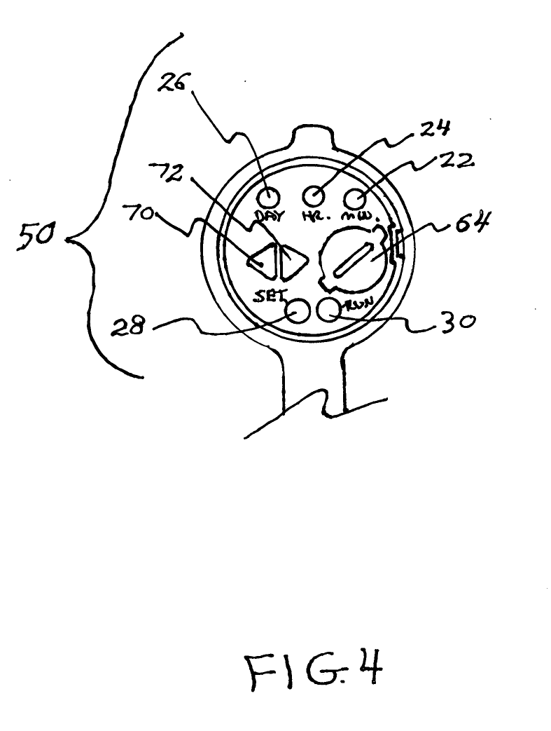

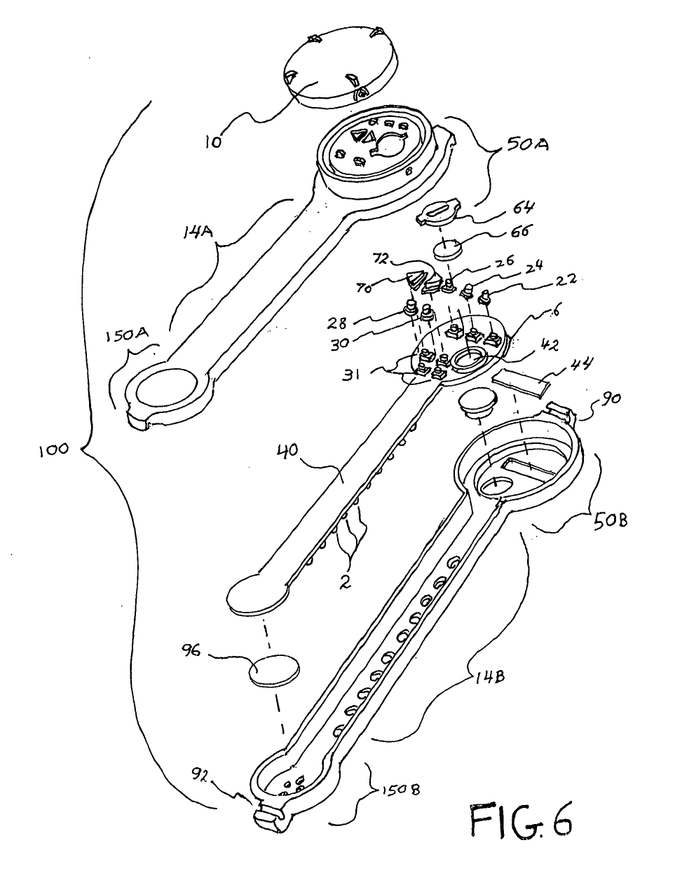

FIG. 3 shows a side section of the invention 100. In this view, a post 12 and hole 13 configuration can be seen at the side of cover 10. The cover 10 can be removed by inserting a small diameter implement such as a ball point pen tip in to the hole 13 thereby depressing post 12 which allows cover 10 to be removed. This configuration allows an adult to set the time in area 50 as shown in FIG. 4 and to then replace cover 10 so that a small child can not accidentally re-set the time while holding the invention 100. The time is set by pushing either the day switch 26, the hour switch 24 or the minute switch 22 and advancing the time by advance switch 70 or recede switch 72 and then pushing the “set” button 28 when the proper time is indicated on the LCD display 6 located on the front of portion 50. The user then presses the “run” switch 30 which starts the timer counting down from the set time, to zero. A battery door 20 holds in place a battery 66 as shown in FIG. 6.

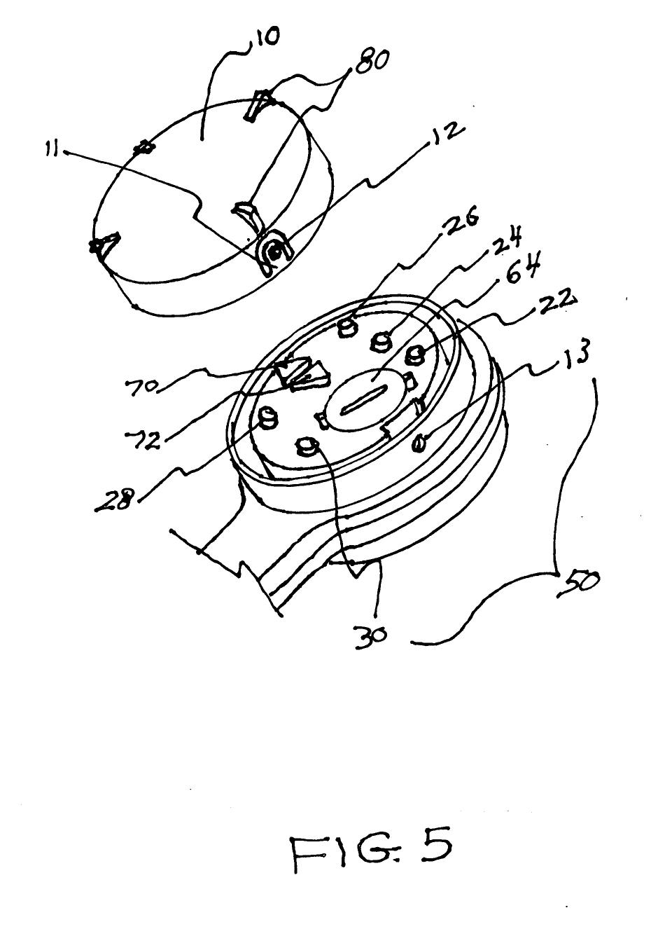

FIG. 5 shows a partial exploded view showing more clearly the standard post 12 and aperture mechanism used for retaining cover 10. Tab 11 can flex to allow post 12 to push in as it is being flexed inward by an implement such as the tip of a pen or pencil. Pull tabs 80 allow the user to remove the cover 10 after post 12 has been dislodged from aperture 13

FIG. 6 shows an exploded view of the entire invention 100. In this view, one can see printed circuit board 40 holding in place LED lights 2. Other components shown are audio transducer 96, battery holder 42 and battery 66, as well as switch actuation covers 22, 24, 26, 28, 30, 70, 72 and their respective momentary switches 30. The housing is shown in halves. the bottom half comprised of 150A 14A and 50A and the top half comprised of 150B, 14B and 50B, shown here upside down for clarity purposes.

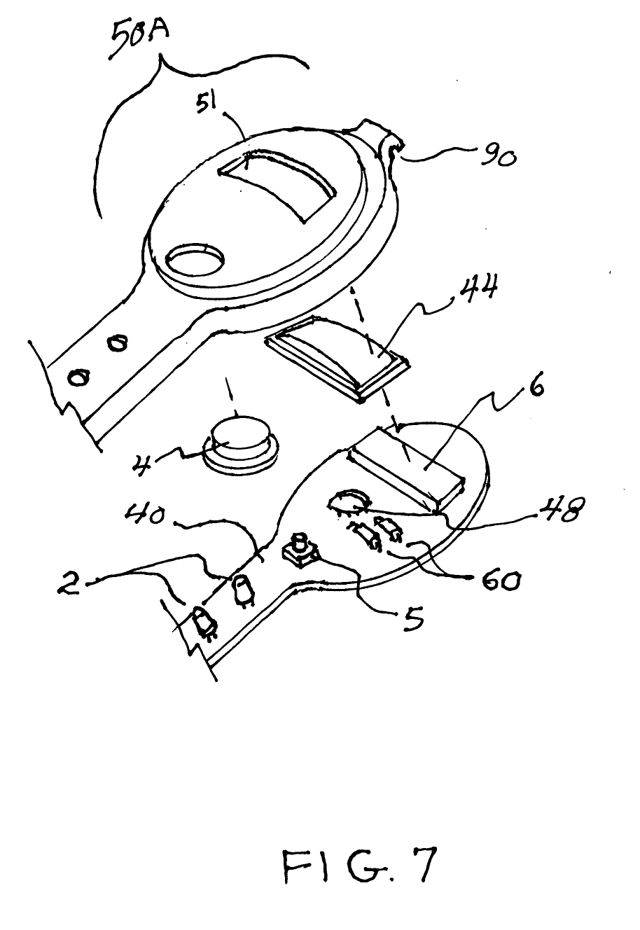

FIG. 7 shows a partial exploded view of the top housing portion 50A and transparent LCD cover 44 which inserts into aperture 51. Also shown are the necessary components mounted onto printed circuit board 40 including LCD display 6, count down timing microprocessor 48, support electronics 60, portion display activation switch 5 and switch cover 4 as well as portion timing LED's 2

The above description and accompanying drawings show a novel count down timer that incorporates a proportional visual display which helps a person see and understand the time remaining in relationship to the total time set by the user.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. proportional count down timer comprising:
a housing including a top and bottom cover;
a tamper proof time setting cover;
a printed circuit board;
an LCD display;
a visual proportion display;
an auditory signal;
a micro-controller circuit;
a power supply such as a battery;
a battery holder;
a battery cover;
a plurality of standard time setting switches including a day function, an hour function and a minute function and a start switch;
a switch that activates said visual proportion display;
said LCD display, said proportion display and said proportion display switch visible through apertures in said top housing;
said battery and said time setting switches accessible by removal of said tamper proof time setting cover;
said time setting switches capable of setting a time including days, hours and minutes which will start counting down upon pressing said start switch;
said LCD display showing amount of actual time left after the push of said start switch;
said visual proportion display showing the proportion of time left after the push of said start switch:
and said auditory signal sounding when the time remaining reaches zero.

2. Proportional count down timer as claimed in claim 1 wherein said visual proportional display consists of a plurality of evenly spaced LED's where said LED's sequentially turn off as time elapses;
for example, if the said proportional display consists of a series of ten LED's, and the said count down timer was set for one hour, after thirty minutes, five LED's would remain lit;
and if the said count down timer was set for four hours, after two hours, five LED's would remain lit.

3. Proportional count down timer as claimed in claim 1 wherein said tamper proof setting cover includes a child proof means to remove said cover such as a standard post and hole closure that can be released by pushing on the end of said post by means of a small diameter implement such as the tip of a pen or pencil.

4. Proportional count down timer as claimed in claim 1 wherein said visual portion display switch activates said display for a fixed short period after which said display turns off thereby saving battery power.
